(19) United States
(12) Patent Application Publication
(10) Pub. No.: US 2011/0148099 A1
(43) Pub. Date: Jun. 23, 2011

(54) LOW STRESS HOSE COUPLING

(75) Inventor: MARK ALLAN LAMONTIA, Landenberg, PA (US)

(73) Assignee: E.I. DU PONT DE NEMOURS AND COMPANY, Wilmington, DE (US)

(21) Appl. No.: 12/641,676

(22) Filed: Dec. 18, 2009

(51) Int. Cl. F16L 47/00

(52) U.S. Cl. 285/258

(57) ABSTRACT

An improved umbilical hose end coupling that comprises a sleeve and an insert for the sleeve, the insert having a hose end for insertion into the hose and the sleeve having a hose end for covering the exterior of the hose and the insert, and the insert and sleeve each having a coupling end for engaging each other, and the sleeve having an interior surface for gripping the hose, the interior surface having at least a length that extends beyond the end of the teeth region onto the hose.

### BACKGROUND OF THE INVENTION

1. Field of the Invention

This invention relates to an improved umbilical hose coupling that is useful with textile-reinforced hoses employed in the oil and gas industry, especially high-pressure thermoplastic hoses for use in offshore systems.

2. Description of the Related Art

FIG. 1 shows a longitudinal section view of one prior art embodiment of a swaged (or crimped) hose coupling 1 with a reinforced hose 2 having a layer of a textile 5 sandwiched between an inner liner 8 and an outer cover 7. The hose coupling has a sleeve 3 and an insert 4, each having a set of teeth in the area represented by 6 that engages the hose when the coupling is swaged or crimped. For the purposes herein, the words crimped and swaged are used interchangeably to mean the sleeve is radially pressed or compressed onto the hose and insert. For the purposes herein, the end where the sleeve and insert engage each other is called the coupling end while the end terminating at the hose is called the hose end. The sleeve and insert are shown with sharp-edged or rectangular teeth. It has been found in some instances that when such hoses are pressurized, the hose fails at the hose end of the coupling. It is thought that the hose fails because the hose in that area experiences two highly-localized elevated stress concentrations created by 1) the last sharp-edged rectangular tooth or teeth on the hose end of the sleeve as indicated by S₁ in FIG. 1 and by 2) the edge of the sleeve acting on the hose end where the hose finally leaves the coupling as indicated by S₂ in FIG. 1. It is believed the sharp edges of the last tooth and the sleeve end impose local stresses at the cover and textile reinforcement when the hose radially expands under internal pressure loading. Large, penetrating, sharp-edged projections or teeth on the sleeve at the hose end of the coupling, therefore, are thought to contribute to the failure of such hoses. Sharp-edged or abruptly ending sleeve ends on the hose side can similarly contribute to the failure of such hoses.

U.S. patent application Ser. No. 12/267,931, filed Nov. 10, 2008 and also assigned to E.I. du Pont de Nemours and Company is directed to an improved hose coupling that is useful with high pressure textile-reinforced hoses in the oil and gas industry, the sleeve of the coupling having at least one rounded annular tooth at the hose end of the coupling and rectangular annular teeth at the coupling end of the coupling. It is thought that rounded teeth help reduce localized stresses in the hose at the hose end of the coupling. This invention addresses the first of two sources of stress concentration—the contribution of the teeth. However effective this invention is with the stress concentration created at the teeth, a need remains to find other remedies to decrease stresses within the hose coupling due to the stress concentration at the sleeve edge.

### BRIEF SUMMARY OF THE INVENTION

In one embodiment, this invention is directed to a hose coupling adapted for use with a hose, comprising:

a tube-like sleeve having a teeth region in a portion of its inside diameter for gripping the hose and a tube-like insert for the sleeve wherein the insert has a teeth region in a portion of its outside diameter for gripping the hose; the insert having a hose end for insertion into the hose and the sleeve having a hose end for covering the exterior of the hose and the insert; and the insert and sleeve each having a coupling end for engaging each other; and wherein the sleeve has a flange that extends beyond the hose end of the teeth region of the sleeve.

### BRIEF DESCRIPTION OF THE DRAWINGS

FIG. 1 is a perspective longitudinal section view of one prior art embodiment of an uncrimped hose coupling including a sleeve, an insert, and a hose.

FIG. 2 is a longitudinal section view of one embodiment of the present invention under operating conditions.

FIG. 3A is a longitudinal section view of one embodiment of the present invention under testing conditions

FIG. 3B is a magnified longitudinal section view of a selected portion of FIG. 3A.

### DETAILED DESCRIPTION OF THE INVENTION

This invention relates to an improved hose coupling that is useful with high pressure textile-reinforced hoses in the oil and gas industry. The sleeve of the coupling has a flange that extends beyond the end of the teeth region over the hose. The coupling typically comprises a tube-like sleeve with a tube-like insert. Hoses tend to be circular and, as such, so would the sleeve and insert; but other shapes are not foreclosed. Hoses that fail at the hose end of the coupling under the influence of pressure loading usually fail in the region of contact between the hose end and the first rectangular tooth on the hose end of the sleeve. The incidence of failure can be reduced if the hose can be gripped by the coupling sleeve in a manner such that the load is gradually spread over a greater length as noted above, and with a gradual transition at the hose end, and by using appropriate angles with respect to the coupling centerline, as will be discussed below.

As used herein, the teeth and grooves on the sleeve and insert are understood to be annular, that is they form projections in the case of teeth or indentations in the case of grooves that are continuous around or into the interior of the sleeve or the exterior of the insert.

In some preferred embodiments the grooves and teeth are positioned orthogonally to the axis of the sleeve and insert. In other words, these grooves and teeth are non-helical, meaning at least two of the indentations or grooves, and likewise the teeth or projections, are not connected by being continuous around the periphery like the threads of a screw; that is, at least two of the teeth and/or two of the grooves are spaced apart and separated from one another. In some embodiments, the grooves and teeth can be helically arranged on the annular surface of either the sleeve or insert. In some embodiments, combinations of orthogonal and helical teeth and grooves can be used.

In some embodiments, the teeth and grooves on the sleeve and insert are evenly spaced. In some embodiments, the teeth and grooves are unevenly spaced. In some embodiments, combinations of evenly spaced and unevenly spaced teeth and grooves can be used.

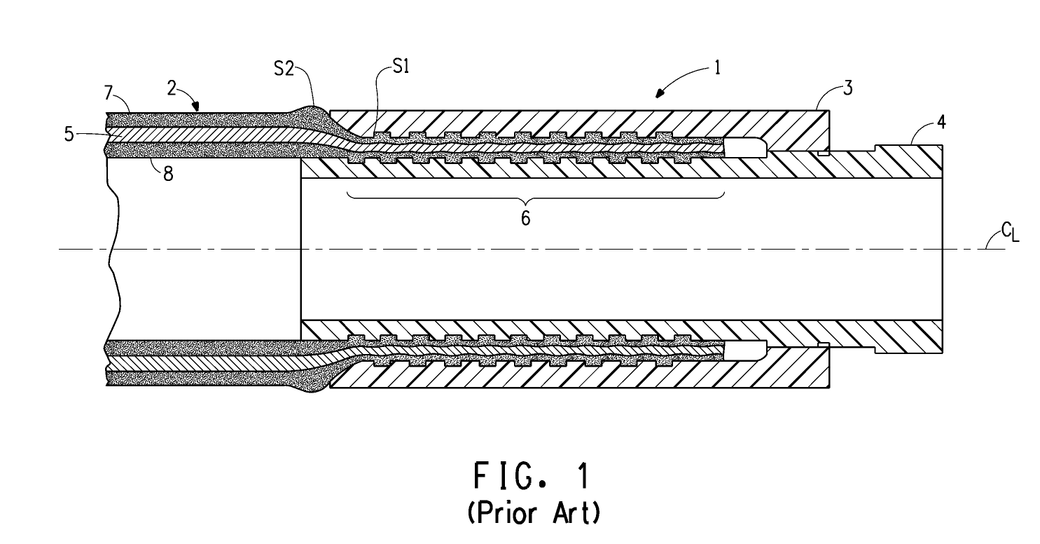

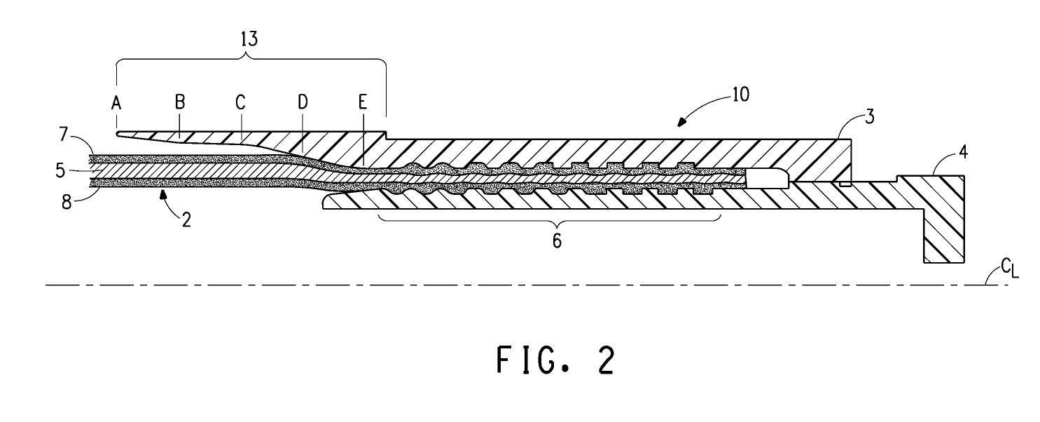

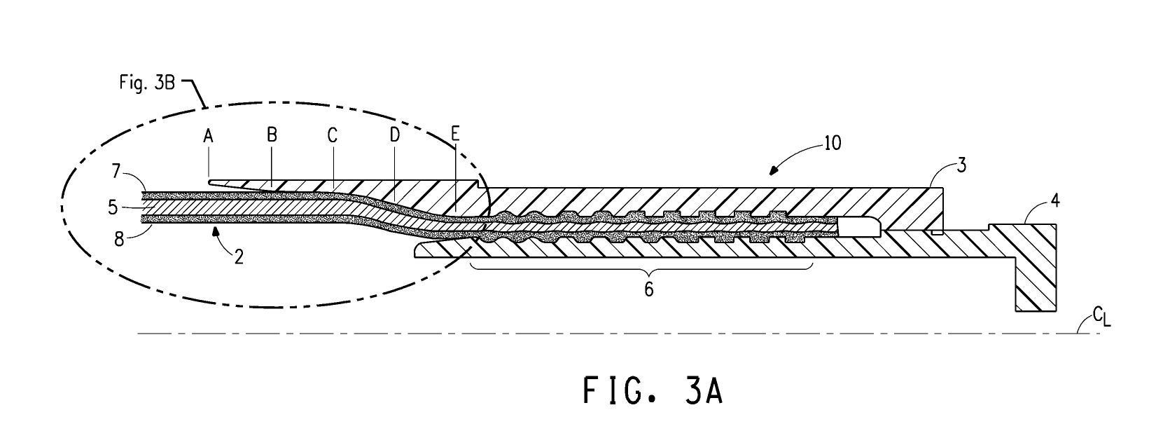

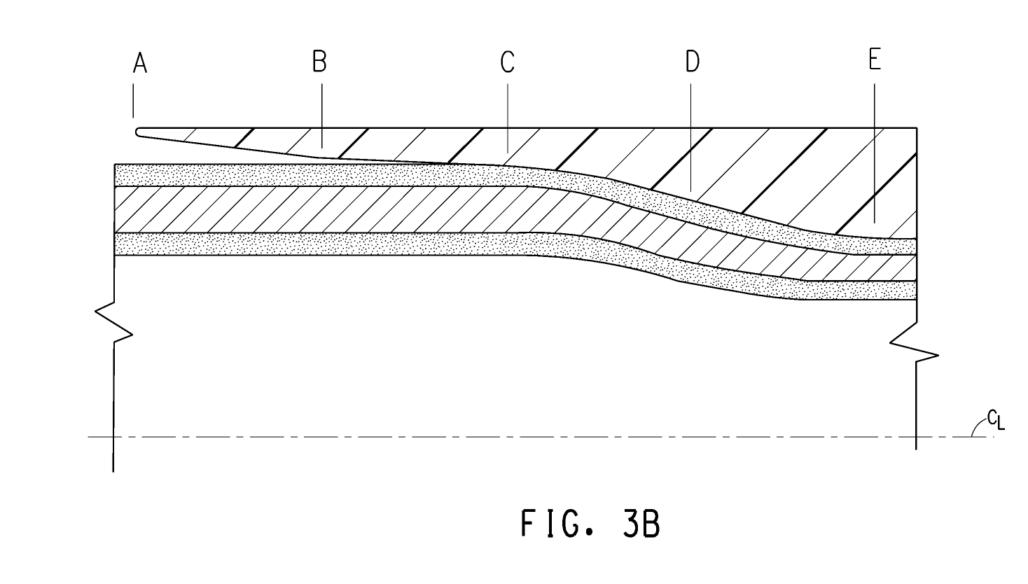

The various embodiments of the subject invention are believed to provide ways to decrease stress concentrations in the hose. FIG. 2 depicts a coupling 10 as one embodiment of the subject invention. It should be noted that for the sake of convenience, FIGS. 2, 3A and 3B show only a top longitudinal portion of the coupling. Certain of the character numbers are the same as used in FIG. 1 (prior art) because they are equivalent for the purposes to be described herein.

In reference to FIG. 2, when hose 2 is subjected to a typical operating pressure (for example, 7500 psi), “D” indicates the contact point of the hose outer diameter. In reference to FIG. 3A, when hose 2 is subjected a maximum test pressure (for example 30,000 psi) “C” indicates the contact point of the hose outer diameter. In this instance, the 30,000 psi test pressure represents a factor of safety of 4 over the operating pressure of 7500 psi. “B” marks the end of the line from “C” to “B,” which would have a zero or nearly zero angle with respect to the hose centerline as the hose contacts the sleeve internal diameter between “B” and “C.” As shown in FIGS. 2 and 3A, sleeve 3 has a flange 13 that extends significantly beyond the hose end of the teeth region of the sleeve. This structure provides at least two attributes: 1) a gradual decrease in the wall thickness of the of the flange to accommodate the increase in diameter of the hose from “E” to “D” during normal operating pressurization or from “E” to “C” during test pressurization, and 2) extending the flange over the hose to enclose it at the operating pressure (at “D”) and at the test pressure (at “C”). Particularly as related to aforementioned attribute 2), the flange prevents the excessive deflection of the hose outer diameter that appears just at the hose end of the sleeve and the associated elevated stress previously identified as S₂. Flange 13 is further extended, as represented by “B” to “A” to minimize the stress concentration effects of the hose flexing (that is, bending back and forth). One wall of hose 3 consists of textile 5 sandwiched between an inner liner 8 and an outer cover 7 that has a thickness “t”. Flange 13 can have a length of at least about 3t, but can vary depending on the thickness of the wall of a particular hose.

As depicted in FIGS. 2 and 3A, there are four zones of interest with respect to the performance of the subject invention.

### Zone 1—“E” to “D” Stress Concentration Control Zone for Operating Pressurization.

In this zone, the sleeve is shaped so that the stress concentration of the sleeve end is minimized when the hose is pressurized to the operating pressure. This is shown in FIG. 2. To do this, the increase in the internal sleeve diameter from “E” to “D” is gradual with smooth transitions wherein “D” is the contact point where the hose contacts the sleeve at the operating pressure.

### Zone 2—“D” to “C” Stress Concentration Control Zone for Test Pressurization.

In this zone, the sleeve is shaped so that the stress concentration of the sleeve end is minimized when the hose is pressurized to the test pressure. This is shown in FIG. 3B. In this zone, the diameter of the hose increases from the coupling end to the hose end. The increase in the sleeve diameter is linear from “D” to “C, wherein C” is the point where the hose contacts the sleeve at the test pressure.

### Zone 3—“C” to “B”—“Hose Capture” Zone.

In this zone, the sleeve just captures the hose at its maximum diameter when pressurized at the internal test pressure. The sleeve angle represented by CB with respect to the centerline should be as shallow as possible and is ideally zero degrees. In practice, the angle from “C” to “B” has some value greater than zero to accommodate tolerances in the hose outside diameter.

### Zone 4—“B” to “A”—“Hose Flexing” Zone.

Zone 4 is present to allow for hose flexing. Zone 4 could be extended from Zone 3 by extending the angle from “C” to “B”, but it is instead turned up merely to shorten the coupling and lower the cost. It does not have to be turned up.

As can be observed with reference to FIG. 3B, Angle CD is the angle that exists between the centerline and the sleeve diameter between points “D” and “C”. Generally, this angle would range from about 5 degrees to about 30 degrees, with the former being the more desirable for performance and the latter yielding the coupling with the shortest length. Angle CB should be very shallow (5 degrees or less) to have the outer diameter of the hose expand into the sleeve without having a kink past the hose end. Angle BA (10 to 20 degrees) is present merely to limit the coupling length and thereby lower the cost. If angle BA were just a continuation of angle CB, the coupling would be excessively long

While the embodiments described above are useful, other embodiments and combinations of features can be used to form suitable hose couplings. The hose coupling is especially useful with textile reinforced hoses, but the hose coupling can also be used with other hoses such as those having other types of layered reinforcement, such as metal reinforcement; or hoses having limited or no reinforcing layers. In some embodiments, such hoses include a thermoplastic covering, a section of textile reinforcement, and a liner. In others, the hose can be thermoplastic elastomeric or even metallic.

Suitable materials useful as covers for the hoses include thermoplastic and/or elastomeric materials or various combinations thereof. Suitable materials useful as liners for the hoses include thermoplastic, elastomeric, and/or fluoropolymer or various combinations thereof. While these materials are especially typical of hoses, essentially any material useful for a hose can be used.

The textile reinforcement can include fiber or yarn that is braided, or the fiber or yarn can be spirally or helically oriented in the hose. The textile reinforcement can also be wound fiber tapes. The preferred textile reinforcement includes aramid fiber, and the most preferred aramid is poly (paraphenylene terephthalamide). Other types of fibers and yarns, such as polyamides, polyesters, glass fiber, carbon fiber, ceramic fiber, and other high strength aramids, polyazoles, extended chain polyetheylenes, and liquid crystal polyesters, or mixtures of any of these materials could also be used if desired.

1. A hose coupling adapted for use with hose, comprising:
a sleeve having a teeth region in a portion of its inside diameter for gripping the hose and a insert for the sleeve wherein the insert has a teeth region in a portion of its outside diameter for gripping the hose; the insert having a hose end for insertion into the hose and the sleeve having a hose end for covering the exterior of the hose and the insert; and the insert and sleeve each having a coupling end for engaging each other; and wherein the sleeve has a flange that extends beyond the end of the teeth region over the hose.

2. The hose coupling of claim 1, wherein the sleeve has a first wall thickness and the flange has a wall thickness that decreasingly tapers from the area adjacent to the hose end of the teeth region to the end of the flange.

3. The hose coupling of claim 2, wherein the flange comprises
a first portion beginning near the hose end of the teeth region and ending at a point where the hose when subjected to a normal operating pressure contacts the inside diameter of the flange, a second portion beginning at a point where the hose when subjected to a normal operating pressure contacts the inside diameter of the flange and ending at a point where the hose when subjected to a test pressure greater than the operating pressure contacts the inside diameter of the flange and a third portion beginning at the point where the hose when subjected to the test pressure contacts the inside diameter of the flange and ending at the extreme hose end of the flange, such that the wall thickness of the e flange decreasingly tapers from the first portion to the third portion.

4. The hose coupling of claim 3, wherein the first portion of the flange forms an angle with respect to the centerline in the range of about 5 to 30° and wherein the second portion of the flange forms an angle with respect to the centerline of less than about 5° and wherein the third portion of the flange forms an angle with respect to the centerline in the range of about 10 to 20°

5. A hose comprising the coupling of either one of claim 1-4.
